(19) United States
(12) Patent Application Publication
(10) Pub. No.: US 2012/0267133 A1
(43) Pub. Date: Oct. 25, 2012

(54) Plow blade kit

(76) Inventor: Curt J. Hill, Warba, MN (US)

(21) Appl. No.: 13/066,675

(22) Filed: Apr. 21, 2011

(51) Int. Cl. A01B 15/00; A01B 23/00; A01B 15/02

(52) U.S. Cl. 172/701.1; 172/762; 172/747

(57) ABSTRACT

A plow blade kit comprising a first plow blade section, a second plow blade section, a connector plate for connecting the first and second plow blade sections together in an end-to-end manner, a first wear bar, a second wear bar, a push tube assembly, mounting components for securing the forward end of the push tube assembly to the rearward sides of the first and second plow blade sections, and a mount for securing the rearward end of the push tube assembly to an off-road vehicle.

### BACKGROUND OF THE INVENTION

1. Field of the Invention

This invention relates to a modular plow blade and more particularly to a plow blade kit suitable for shipment in a box which will be accepted by United Parcel Service.

2. Description of the Related Art

Plow blades are commonly mounted on either the forward or rearward ends of an off-road vehicle such as an ATV, UTV, garden tractor or the like. Normally the blade itself is of one-piece straight blade construction but V-shaped plow blades are also available. Usually the plow blade is secured to the off-road vehicle by an elongated push tube assembly having a plow blade mounted at one end thereof and a vehicle mount assembly at its other end.

The problem with the prior art plow blades is that they are quite large and are difficult to ship. The plow blades of the prior art are too large to be shipped by United Parcel Service which would normally be the preferred mode of shipment. Even if the plow blade and associated structure could fit into the largest shipping box acceptable by UPS, the shipping costs associated with the large box are very costly since the shipping charges are determined by the length, width and girth of the box, as well as the weight of the box and its contents.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A plow blade kit is disclosed which includes the following components: a first plow blade section, a second plow blade section, a first wear bar for attachment to the lower end of the first plow blade section, a second wear bar for attachment to the lower end of the second plow blade section, a connector plate for joining the inner ends of the first and second plow blades together in an end-to-end manner, a push tube assembly, mounting structure for securing one end of the push tube assembly to an off-road vehicle, mounting structure for attaching the other end of the push tube assembly to the plow blade sections, and skids.

It is therefore a principal object to provide a modular plow blade for use on an off-road vehicle.

A further object of the invention is to provide a plow blade kit which may be placed in a UPS shipping box.

A further object of the invention is to provide a plow blade which is comprised of first and second plow blade sections which are joined together in an end-to-end relationship by a connector plate.

A further object of the invention is to provide a plow blade kit of the type described which includes all of the components necessary to mount the plow blade on an off-road vehicle.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a front perspective view of an ATV having the plow blade of this invention mounted on the forward end thereof;

FIG. 2 is a perspective view of the plow blade of the invention which illustrates the connector plate which joins the first and second plow blade sections together in an end-to-end manner;

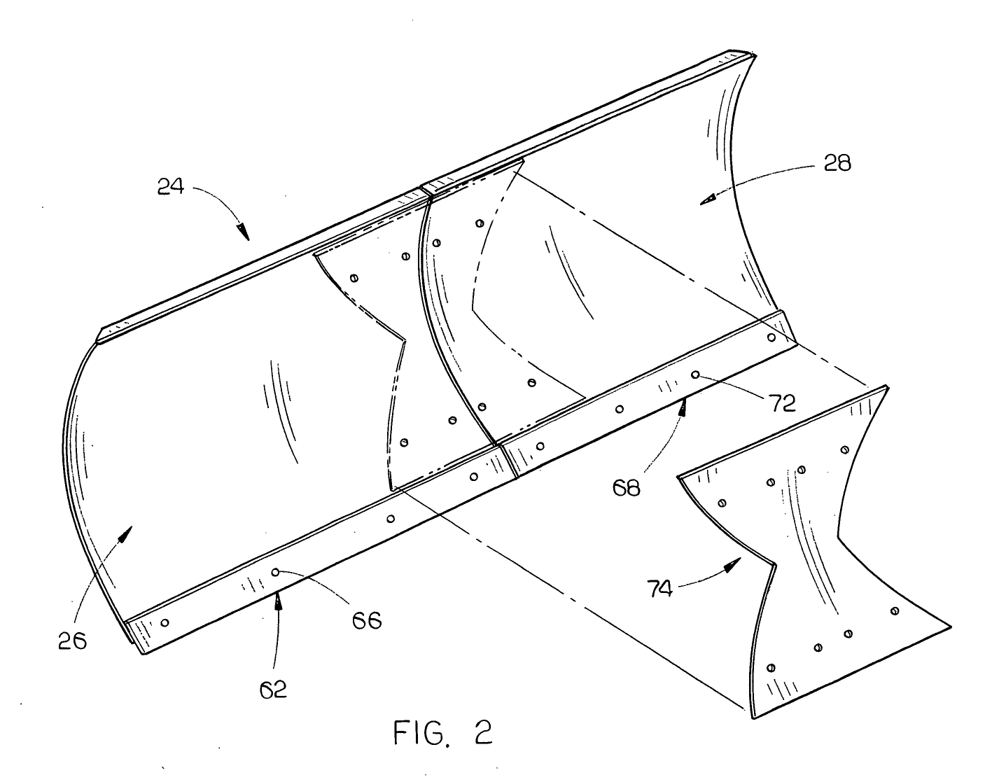

FIG. 3 is an exploded perspective view of the components of the plow blade kit; and

FIG. 4 is a perspective view illustrating the manner in which the components of the plow blade kit may be collected for positioning in a box.

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The numeral 10 refers to an off-road vehicle such as an ATV, UTV, garden tractor, or the like. For purposes of description, the vehicle 10 will be described as having a forward end 12, rearward end 14, left side 16, and right side 18. Normally, the vehicle 10 will also have a winch 20 or the like for raising and lowering a plow blade mounted on either the forward or rearward end of the vehicle 10.

The plow blade kit of this invention is referred to generally by the reference numeral 22. The components of kit 22 are designed so as to be placed in a UPS box or the like and preferably one of the smaller UPS boxes. Kit 22 includes a plow blade 24 which is comprised of a first plow blade section 26 and a second plow blade section 28. Each of the plow blade sections 24 and 26 preferably have a curved vertical cross-section but could have a straight vertical cross-section if so desired. Plow blade 24 may be comprised of steel or plastic.

Plow blade section 26 will be described as having an outer end 30, inner end 32, upper end 34, lower end 36, front side 38 and back side 40. Plow blade section 26 has a pair of spaced-apart bolt openings 42 formed therein adjacent its upper inner end 32 and has a pair of horizontally spaced-apart bolt openings 43 formed therein below the bolt openings 42.

Plow blade section 26 also has a plurality of horizontally spaced-apart openings 44 formed therein adjacent the lower end thereof.

Plow blade section 28 will be described as having an outer end 46, inner end 48, upper end 50, lower end 52, front side 54, and back side 56. Plow blade section 28 has a pair of spaced-apart bolt openings 58 formed therein adjacent its upper inner end 48 and has a pair of horizontally spaced-apart bolt openings 59 formed therein below bolt openings 58. Plow blade section 58 also has a plurality of horizontally spaced-apart bolt openings 60 formed therein adjacent the lower end thereof.

The numeral 62 refers to a first elongated wear bar having a plurality of horizontally spaced-apart openings 64 formed therein which register with bolt openings 44 in plow blade section 26 when the plow blade 24 is assembled. Bolts 66 are included in the kit 22 for securing wear bar 62 to the lower end of plow blade section 26. The numeral 68 refers to a second elongated wear bar having a plurality of horizontally spaced-apart bolt openings 70 formed therein which register with bolt openings 60 and plow blade section 28 when the plow blade 24 is assembled. Bolts 72 are included in the kit 22 for securing wear bar 68 to the lower end of plow blade section 28.

The numeral 74 refers to a connector plate which preferably is X-shaped but could be square-shaped or rectangular-shaped if so desired. Connector plate 74 has a pair of bolt openings 76 formed therein at its upper end and also has a pair of bolt openings 78 formed therein at its upper end. Connector plate 74 has a pair of bolt openings 80 formed therein at its lower end and also has a pair of bolt openings 82 formed therein at its lower end. When plow blade 24 is assembled, openings 76 in connector plate 74 register with the pair of bolt openings 42 in plow blade section 26 and openings 80 in connector plate 74 register with bolt openings 43 in plow blade section 26. When the plow blade 24 is assembled, openings 78 in connector plate 74 register with the pair of bolt openings 58 in plow blade section 28 and openings 82 in connector plate 74 register with the pair of bolt openings 59 in plow blade section 28. Bolts 84 are provided in the kit 22 and extend through the registering bolt openings in connector plate 74 and the bolt openings in the plow blade sections 26 and 28 to connect the plow blade sections 26 and 28 together in an end-to-end relationship.

The numeral 86 refers to a skid mounting plate which is secured to the lower end of plow blade section 26 at the rearward side thereof by the bolts 66 which extend through wear bar 62 and plow blade section 26. Skid 88 is adapted to be secured to skid mounting plate 86. Skid mounting plate 90 is adapted to be secured to the lower end of plow blade section 28 at the rearward side thereof by the bolts 72 which extend through wear bar 68 and plow blade section 28. Skid 92 is adapted to be secured to skid mounting plate 90.

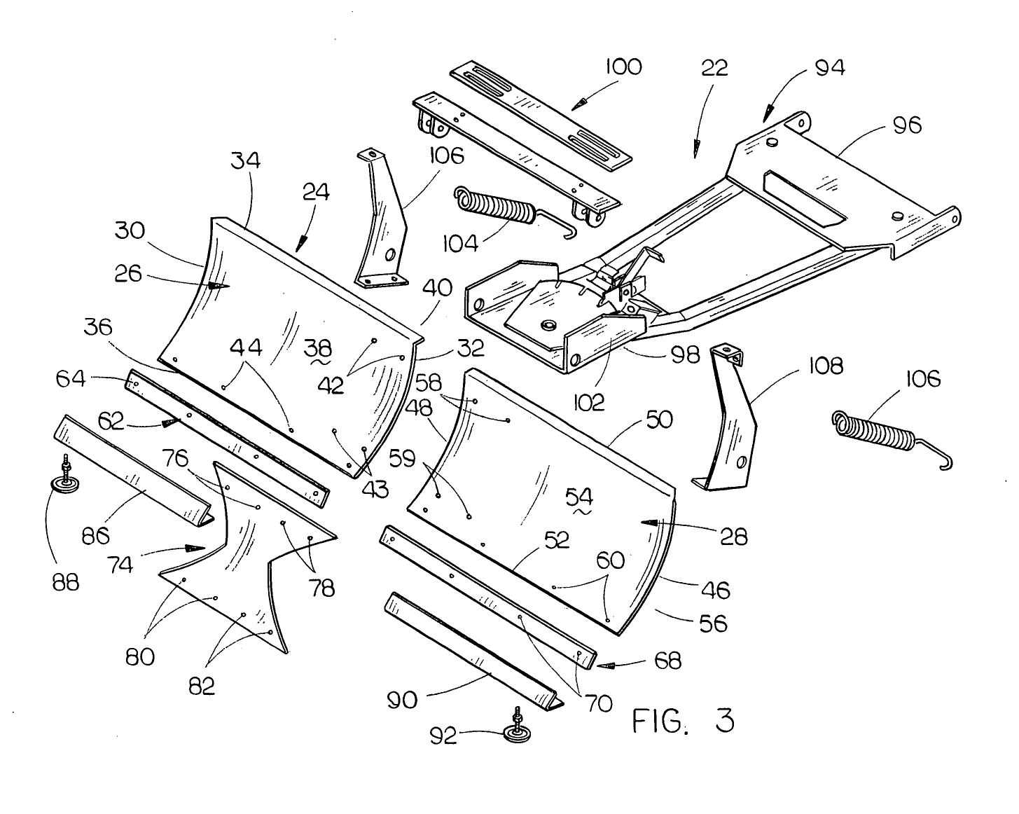

In FIG. 3, the numeral 94 refers to a push tube assembly having a rearward end 96 and a forward end 98. The rearward end 96 of push tube assembly 94 is adapted to be pivotally connected to a mounting bracket assembly 100 which is adapted to be secured to the frame of the vehicle at the underside thereof. A blade mount 102 is mounted on the forward end of push tube assembly 94 and includes springs. Brackets 106 and 108 are adapted to be secured to the rearward sides of plow blade sections 26 and 28 respectively. The blade mount 102 is pivotally connected to brackets 106 and 108. The spring 104 interconnects bracket 106 and blade mount 102. The spring 106 interconnects the bracket 108 and blade mount 102.

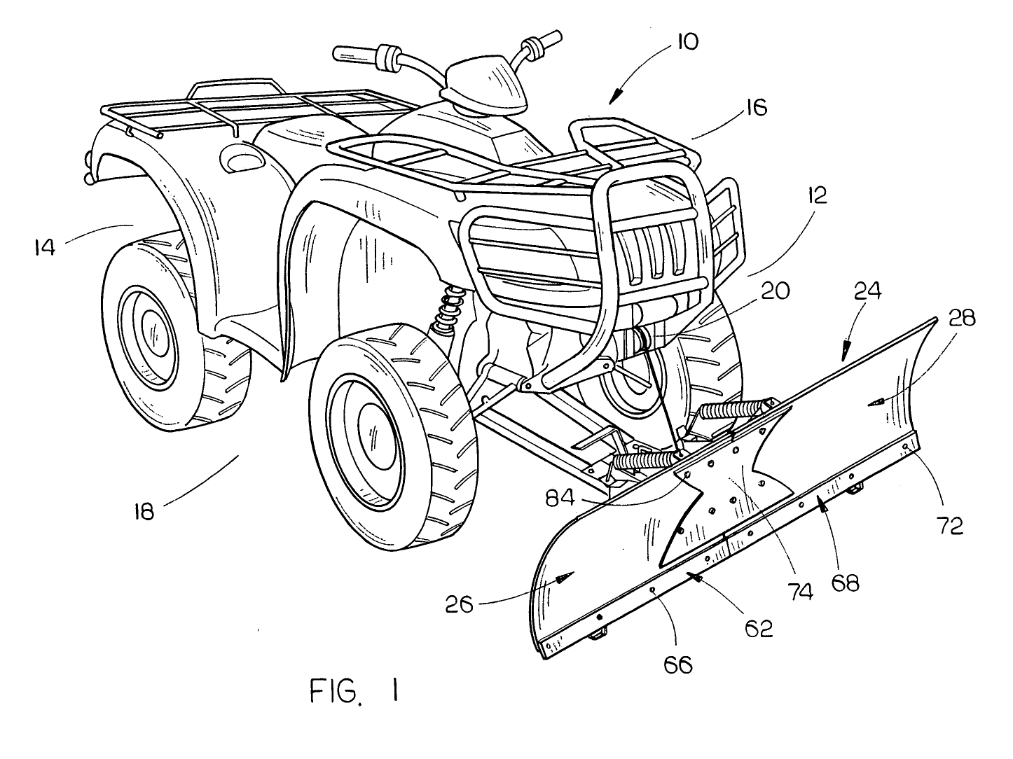

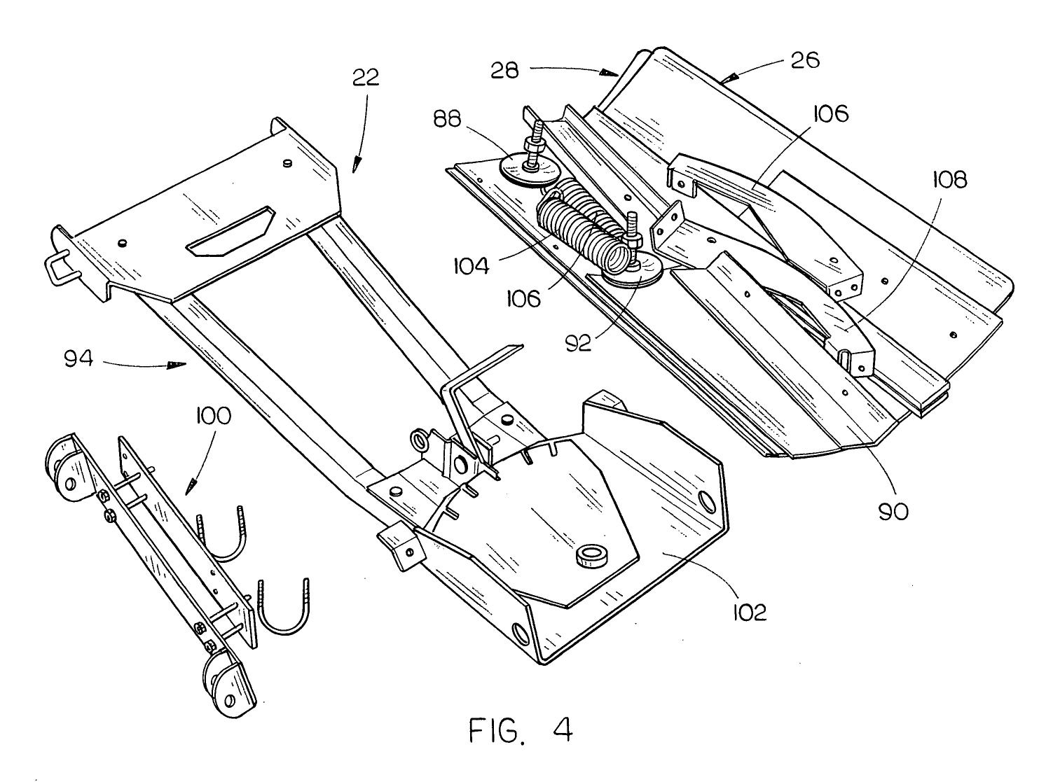

When the plow blade is disassembled as seen in FIG. 4, the plow blade is in kit form and may be shipped in a UPS box or the like. When assembled as seen in FIG. 1, the plow blade functions in conventional fashion. The kit is made possible by the fact that the plow blade 24 is comprised by the plow blade sections 26 and 28 which may be connected together in an end-to-end manner by the connector plate 74.

Thus it can be seen that the plow blade and plow blade kit of this invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

I claim:

1. A plow blade kit suitable for shipment in a UPS box, comprising:
a first generally rectangular-shaped plow blade section having an outer end, an inner end, an upper end, a lower end, a front side and a rear side;
a second generally rectangular-shaped plow blade section having an outer end, an inner end, an upper end, a lower end, a front side and a rear side;
said first plow blade section having a plurality of horizontally spaced-apart first bolt openings formed therein adjacent said lower end thereof;
said first plow blade section having a plurality of spaced-apart second bolt openings formed therein adjacent said inner end thereof;
said second plow blade section having a plurality of horizontally spaced-apart first bolt openings formed therein adjacent said lower end thereof;
said second plow blade section having a plurality of spaced-apart second bolt openings formed therein adjacent said inner end thereof;
a connector plate having an upper end, a lower end, a first end, a second end, a front side and a rear side;
said connector plate having a plurality of spaced-apart bolt openings which register with said second bolt openings in said first and second plow blade sections when said first and second plow blade sections are positioned in an end-to-end relationship with said inner ends of said first and second plow blade sections being in an abutting relationship and said connector plate is positioned at said front sides of said first and second plow blade sections at the juncture thereof;
a plurality of bolts for insertion through said bolt openings in said connector plate and through said second openings in said first and second plow blade sections;
a first generally rectangular-shaped wear plate having an upper end, a lower end, an inner end, and an outer end;
said first wear plate adapted to be selectively removably positioned at said lower end of said first plow blade section;
said first wear plate having a plurality of horizontally spaced-apart bolt openings formed therein;
said bolt openings in said first wear plate registering with said first bolt openings in said first plow blade section when said first wear plate is positioned at said lower end of said first plow blade section;
a plurality of bolts for insertion through said bolt openings in said first wear plate and through said first bolt openings in said first plow blade section;
a second generally rectangular-shaped wear plate having an upper end, a lower end, an inner end, and an outer end;
said second wear plate adapted to be selectively removably positioned at said lower end of said second plow blade section;
said second wear plate having a plurality of horizontally spaced-apart bolt openings formed therein;
said bolt openings in said second wear plate registering with said first bolt openings in said second plow blade section when said second wear plate is positioned at said lower end of said second plow blade section;
a plurality of bolts for insertion through said bolt openings in said second wear plate and through said first bolt openings in said second plow blade section;
and a push tube assembly having a forward end and a rearward end;
said forward end of said push tube assembly adapted to be secured to said rear sides of said first and second plow blade sections;
said rearward end of said push tube assembly adapted to be secured to an off-road vehicle.

2. The plow blade kit of claim 1 further including a mount assembly for securing said rearward end of said push tube assembly to the off-road vehicle.

3. The plow blade kit of claim 1 wherein each of said first and second plow blade sections have a curved vertical cross-section.

4. The plow blade kit of claim 1 wherein said connector plate is generally rectangular in shape.

5. The plow blade kit of claim 1 wherein said connector plate is generally square-shaped.

6. The plow blade kit of claim 1 wherein said connector plate is generally X-shaped.

7. The plow blade kit of claim 1 wherein said first and second plow blade sections are comprised of a steel material.

8. The plow blade kit of claim 1 wherein said first and second plow blade sections are comprised of a plastic material.

9. A plow blade comprising:
a first generally rectangular-shaped plow blade section having an outer end, an inner end, an upper end, a lower end, a front side and a rear side;
a second generally rectangular-shaped plow blade section having an outer end, an inner end, an upper end, a lower end, a front side and a rear side;
said first plow blade section having a plurality of spaced-apart first bolt openings formed therein adjacent said inner end thereof;
said second plow blade section having a plurality of spaced-apart first bolt openings formed therein adjacent said inner end thereof;
a connector plate having an upper end, a lower end, a first end, a second end, a front side and a rear side;
said connector plate having a plurality of spaced-apart bolt openings which register with said first bolt openings in said first and second plow blade sections when said first and second plow blade sections are positioned in an end-to-end relationship with said inner ends of said first and second plow blade sections being in an abutting relationship and said connector plate is positioned at said front sides of said first and second plow blade sections at the juncture thereof; and
bolts extending through said bolt opening sin said connector plate and through said first openings in said first and second plow blade sections.

10. The plow blade of claim 9 wherein said connector plate is generally rectangular-shaped.

11. The plow blade of claim 9 wherein said connector plate is generally square-shaped.

12. The plow blade of claim 9 wherein said connector plate is generally X-shaped.

13. The plow blade of claim 9 wherein each of said first and second plow blade sections and said connector plate has a curved vertical cross-section.

14. The plow blade of claim 9 wherein said first and second plow blade sections are comprised of a steel material.

15. The plow blade of claim 9 wherein said first and second plow blade sections are comprised of a plastic material.

16. A plow blade comprising:
a first generally rectangular-shaped plow blade section having an outer end, an inner end, an upper end, a lower end, a front side and a rear side;
a second generally rectangular-shaped plow blade section having an outer end, an inner end, an upper end, a lower end, a front side and a rear side;
said first plow blade section having a plurality of spaced-apart first bolt openings formed therein adjacent said inner end thereof;
said second plow blade section having a plurality of spaced-apart first bolt openings formed therein adjacent said inner end thereof;
a connector plate having an upper end, a lower end, a first end, a second end, a front side and a rear side;
said connector plate having a plurality of spaced-apart bolt openings which register with said first bolt openings in said first and second plow blade sections when said first and second plow blade sections are positioned in an end-to-end relationship with said inner ends of said first and second plow blade sections being in an abutting relationship and said connector plate is positioned at said back sides of said first and second plow blade sections at the juncture thereof; and
bolts extending through said bolt opening sin said connector plate and through said first openings in said first and second plow blade sections.

17. The plow blade of claim 9 wherein a first wear plate is secured to said first plow blade section at the lower end thereof and wherein a second wear plate is secured to said second plow blade section at the lower end thereof.

18. The plow blade of claim 16 wherein said first and second plow blade sections are comprised of a steel material.

19. The plow blade of claim 16 wherein said first and second plow blade sections are comprised of a plastic material.
